(19) United States
(12) Patent Application Publication
(10) Pub. No.: US 2008/0219294 A1
(43) Pub. Date: Sep. 11, 2008

(54) Network Element Manager Resynchronization

(75) Inventor: Michael J. Landers, Cork (IE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/995,133

(22) PCT Filed: Jun. 23, 2006
(86) PCT No.: PCT/US2006/024445

§ 371 Date: Jan. 9, 2008

(30) Foreign Application Priority Data
Sep. 2, 2005 (GB) 0517901.5

(51) Int. Cl. H04J 3/06

(52) U.S. Cl. 370/503

(57) ABSTRACT

A network element manager (111) manages a plurality of network elements 101-109 of a communication system. The network element manager (111) comprises a service processor (213) which is arranged to detect a service resumption following a service disruption which is associated with the plurality of network elements 101-109. An ordering processor (211) determines an order of resynchronization for the plurality of network elements 101-109 in response to at least one operational characteristic of the plurality of network elements 101-109. The operational characteristic can be a capacity or traffic level supported by the network element 101-109. A resynchronization processor (209) then resynchronizes the plurality of network elements 101-109 following the service resumption in the determined order of resynchronization. The invention can specifically improve resynchronization performance in a cellular communication system.

### FIELD OF THE INVENTION

The invention relates to a network element manager, a cellular communication system and a method of resynchronization for a plurality of network elements and in particular, but not exclusively, to resynchronization following a service disruption associated with a network element manager of a cellular communication system.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems are currently being rolled out to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

The efficient management of a cellular communication system is critical to achieving high performance, efficient utilisation of the available resource and a high quality of service.

In a fixed network of a cellular communication system, a network element manager is typically employed to manage and control a number of network elements. The responsibilities of such a network element manager typically include the management and control of the configuration and operational state of the network elements. In addition, the network element manager monitors the operation of the network elements and gathers operating statistics for these. Also, the network element manager may typically provide a user interface that allows a network operator to monitor the operation of the network and to manually modify characteristics of the network. For example, the alarm status for network elements may be presented to the network operator. In response, the network operator may e.g. manually reset the alarm or enter the corresponding network element into a different operating state to compensate for a fault causing the alarm.

Although such a system may efficiently control a number of network elements during normal operation, service disruptions may occur during which this cannot be achieved. For example, a communication disruption may occur preventing the network element manager communicating with a number of the managed network elements. Such a communication disruption can for example occur due to a hardware fault resulting in a link outage. As another example, the network element manager may be upgraded requiring it to be offline or requiring a restart.

Following such a service interruption, it is necessary to resynchronize the network element manager and the affected network elements. Such resynchronization is essential in order to give the network operator an accurate view of the condition of the network.

Conventionally, network element managers are generally programmed to automatically resynchronize this information when the links to the network elements are brought back into service. Typically, network element managers also comprise functionality allowing the network operator to manually resynchronize one or more network elements if required.

However, a problem with existing systems is that such resynchronization is time consuming and suboptimal resulting in a suboptimal recovery of the network leading to a degraded performance of the communication system as a whole.

Hence, an improved network element manager and method therefor would be advantageous, and in particular a system allowing increased flexibility, improved resynchronization, reduced impact of service disruptions and/or improved performance of the network would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a network element manager for managing a plurality of network elements of a communication system, the network element manager comprising: means for detecting a service resumption following a service disruption associated with the plurality of network elements; ordering means for determining an order of resynchronization for the plurality of network elements in response to at least one operational characteristic of the plurality of network elements; and resynchronizing means for resynchronizing the plurality of network elements following the service resumption in the determined order of resynchronization.

The Inventor of the current invention has realised that improved performance can be achieved by performing an ordered and improved resynchronization following a service disruption associated with a network element manager. In particular, the Inventor has realised that improved performance can be achieved by an ordered resynchronization of network elements in response to one or more operational characteristics of the affected network elements. The invention can reduce the impact of a service disruption and can improve performance of the communication system as a whole. For example, network elements having a particularly high impact on the performance of the communication system can be resynchronized before network elements having less impact.

According to an optional feature of the invention, the ordering means is arranged to determine an operational characteristic for each of the plurality of network elements and to order the plurality of network elements in order of the operational characteristic.

This can allow a practical implementation and/or improved resynchronization performance.

According to an optional feature of the invention, the at least one operational characteristic comprises a capacity characteristic for each of the plurality of network elements.

This can allow improved resynchronization performance and/or can allow improved recovery and/or reduced impact of service disruptions. The capacity characteristic can be a passive capacity characteristic such as a potential for supporting communications and/or can be an active capacity characteristic such as the capacity of communications actually supported by the individual network elements. In some embodiments, network elements can be resynchronized in order of decreasing capacity.

The feature can for example allow a resynchronization having a faster rate of increase of the combined available capacity following a service disruption.

According to an optional feature of the invention, the at least one operational characteristic comprises a fault characteristic for each of the plurality of network elements. The fault characteristic can comprise a fault frequency prior to the service resumption.

This can allow improved resynchronization performance and/or can allow improved recovery and/or reduced impact of service disruptions. The fault characteristic can for example be a frequency of faults, a rate of faults or an indication of whether the network element was in a fault state when the service disruption occurred.

According to an optional feature of the invention, the at least one operational characteristic comprises an alarm characteristic for each of the plurality of network elements. The alarm characteristic can comprise an alarm frequency prior to the service resumption.

This can allow improved resynchronization performance and/or can allow improved recovery and/or reduced impact of service disruptions. The alarm characteristic can for example be a frequency of alarms, a rate of alarms or an indication of whether the network element was in an alarm state when the service disruption occurred.

According to an optional feature of the invention, the at least one operational characteristic comprises a priority characteristic for each of the plurality of network elements.

This can allow improved resynchronization performance and/or can allow improved recovery and/or reduced impact of service disruptions. The priority characteristic can be a priority manually assigned to network elements or can e.g. be a priority determined in response to dynamic characteristics for the individual network elements. In some embodiments, network elements can be resynchronized in order of decreasing priority.

According to an optional feature of the invention, the at least one operational characteristic comprises a traffic characteristic for each of the plurality of network elements.

This can allow improved resynchronization performance and/or can allow improved recovery and/or reduced impact of service disruptions. The traffic characteristic of a network element can be an indication of the communication traffic supported by the network element prior to the service disruption. In some embodiments, network elements can be resynchronized in order of decreasing supported traffic. The feature can for example allow a resynchronization having a faster rate of increase of the supported traffic following a service disruption.

According to an optional feature of the invention, the network element manager further comprises means for dynamically determining the at least one operational characteristic for each of the plurality of network elements during non-service-disrupted operation.

This can allow a practical implementation and/or improved resynchronization performance. In particular, the feature can allow an automatic determination of a suitable resynchronization order depending on the dynamic characteristics of the network. The network element manager can for example collect and store parameters of the operation of the network elements and can store these during normal operation. The resynchronization order can be determined, e.g. during a service disruption, using the stored values.

According to an optional feature of the invention, the at least one operational characteristic comprises a communication characteristic at the service disruption.

This can allow a practical implementation and/or improved resynchronization performance. In particular, an improved resynchronization reflecting the current communication conditions at service disruption can be achieved.

According to an optional feature of the invention, the service disruption comprises a communication disruption between the network element manager and at least one of the plurality of network elements.

The invention can allow improved resynchronization following a communication disruption. The communication disruption can for example be a fault of a communication link and/or of functionality supporting a communication link.

According to an optional feature of the invention, the resynchronizing means is arranged to sequentially synchronize information between the network element manager and each of the plurality of network elements in the resynchronization order.

This can allow an improved resynchronization following a service disruption.

According to an optional feature of the invention, the information comprises network element configuration data.

The invention can allow improved synchronization of configuration information between a network element manager and network elements following a service disruption.

According to an optional feature of the invention, the information comprises network element state data.

The invention can allow improved synchronization of network element state information between a network element manager and network elements following a service disruption.

According to an optional feature of the invention, the information comprises network element alarm data.

The invention can allow improved synchronization of alarm information between a network element manager and network elements following a service disruption.

According to an optional feature of the invention, the communication system is a cellular communication system.

The invention can allow improved performance in a cellular communication system such as a GSM or UMTS cellular communication system.

According to another aspect of the invention, there is provided a cellular communication system comprising a network element manager managing a plurality of network elements, the network element manager comprising: means for determining a service resumption following a service disruption associated with the plurality of network elements; ordering means for determining an order of resynchronization for the plurality of network elements in response to at least one operational characteristic of the plurality of networks; and resynchronizing means for resynchronizing the plurality of network elements following the service resumption in the determined order of resynchronization.

According to another aspect of the invention, there is provided a method of resynchronization for a plurality of network elements of a communication system, the method comprising: determining a service resumption following a service disruption associated with the plurality of network elements; determining an order of resynchronization for the plurality of network elements in response to at least one operational characteristic of the plurality of networks; and resynchronizing the plurality of network elements following the service resumption in the determined order of resynchronization.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a GSM cellular communication system comprising a network element manager in accordance with some embodiments of the invention;

FIG. 2 illustrates a network element manager in accordance with some embodiments of the invention; and

FIG. 3 illustrates a method of resynchronization for a plurality of network elements of a communication system in accordance with some embodiments of the invention.

### DETAILED DESCRIPTION OF SOME EMBODIMENTS OF THE INVENTION

The following description focuses on embodiments of the invention applicable to a cellular communication system and in particular to a GSM cellular communication system. However, it will be appreciated that the invention is not limited to this application but may be applied to many other communication systems including for example 3^{rd} generation cellular communication systems, such as UMTS.

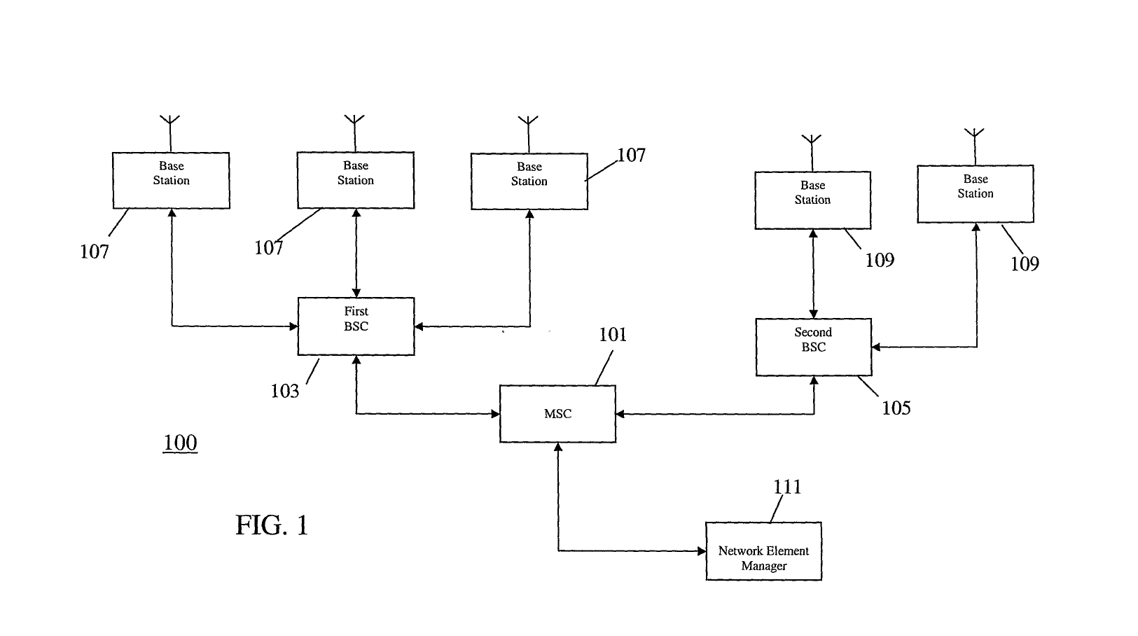

FIG. 1 illustrates a GSM cellular communication system comprising a network element manager in accordance with embodiments of the invention.

In the example, the cellular communication system comprises a mobile switching centre (MSC) 101. The MSC 101 is coupled to a plurality of base station controllers (BSC) 103, 105 of which two are shown. Each BSC 103, 105 is coupled to a number of base stations 107, 109 which communicate with mobile terminals (not shown) over the air interface of the GSM communication system.

In a GSM cellular communication system, the base stations are responsible for maintaining the air interface communication links to the mobile stations. The BSCs 103, 105 perform many of the control functions related to the air interface including radio resource management and routing of data to and from appropriate base stations.

An MSC interconnects BSCs and is operable to route data between two BSCs, thereby enabling a mobile station in a cell to communicate with a mobile station in any other cell. In addition, an MSC typically comprises gateway functions for interconnecting to external networks such as the Public Switched Telephone Network (PSTN). Furthermore, the MSC comprises much of the functionality required for managing a conventional cellular communication network.

It will be appreciated, that a typical GSM cellular communication system typically comprises a large number of base stations, a significant number of BSCs, and possibly a plurality of MSCs.

In the example of FIG. 1, the MSC 101 is coupled to a network element manager 111. The network element manager 111 may for example be an Operations and Maintenance Centre (OMC) or may be part of an OMC.

An OMC typically comprises functionality for interfacing with a network operator in order to allow the network operator to manage and control the cellular application system.

In the example of FIG. 1, the network element manager 111 is arranged to manage, control and monitor the operation of a number of network elements 101-109. In particular, the network element manager 111 is arranged to control and manage the illustrated BSCs 103, 105, base stations 107, 109 and MSC 101.

Specifically, the network element manager 111 can control the operational state and configuration of the network elements 101-109 by downloading operation, control and configuration parameters to the network elements 101-109. Also, the network elements 101-109 can upload operational data and performance characteristics to the network element manager 111.

Although such an arrangement can provide efficient performance, a significant degradation can occur if a service disruption occurs to the network element manager 111. For example, a communication disruption can prevent the network element manager 111 communicating with the network elements 101-109. E.g. if the communication link between the MSC and the first BSC 103 is disrupted due to a hardware fault, the network element manager 111 will not be able to download configuration data to or receive performance status data from the first BSC 103 or from the base stations 107 supported by the first BSC 103.

Similarly, if the network element manager 111 develops a fault or a shutdown/restart is necessary (for example due to an update or reconfiguration of the network element manager 111 software), the information exchange between the network element manager 111 and the network elements 101-109 will be disrupted. Accordingly, when normal service is resumed, the status of the network element manager 111 and the network elements can not be accurately synchronized.

Following a service disruption it is generally necessary to resynchronize the network element manager 111 and the network elements 101-109 to each other. In particular, the state information for the network must be resynchronized at the network element manager 111 in order to give the network operator an accurate view of the current condition of the network. Such resynchronization can typically comprise resynchronizing information including network element alarm data, network element device state data, network element configuration data and network element performance (statistical) data.

It will be appreciated that the resynchronization can in principle comprise both uploading of data from the network elements 101-109 to the network element manager 111, as well as downloading of data from the network element manager 111 to the network elements 101-109. For example, the network elements 101-109 can upload information relating to active alarms, faults or performance characteristics thereby allowing the network element manager 111 to have an accurate record of the current state of the network elements 101-109. The network element manager 111 can in return download configuration data to the network elements 101-109 thereby ensuring that these are configured according to the current configuration prescribed by the network element manager 111. This can for example ensure that a network element is configured correctly following a service disruption even if a configuration command from the network element manager 111 is lost prior to the detection of the service disruption (such as a communication link loss).

Conventionally such resynchronization is performed in an ad-hoc manner wherein network elements are synchronized in a manner that does not optimise the performance of the cellular communication system.

For example, it has been known to resynchronize network elements alphabetically by network element name, by network element identifier or by the order in which the network elements were first registered in the element manager. However, such conventional approach results in suboptimal performance following a service disruption.

In accordance with the present invention, the network element manager 111 of FIG. 1 comprises functionality for improving resynchronization performance following a service disruption. Specifically, the element manager 111 comprises functionality for performing a resynchronization process wherein network elements 101-109 are ordered in response to performance characteristics of the network elements. The network elements 101-109 are then resynchronized in the determined order.

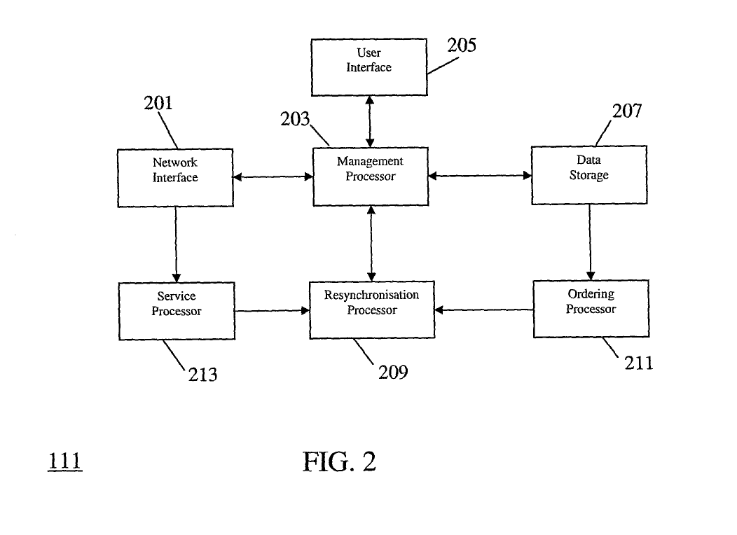

FIG. 2 illustrates the network element manager 111 in accordance with some embodiments of the invention.

The network element manager 111 comprises a network interface 201 which has functionality for interfacing with the fixed network of the cellular communication system. In the example of FIG. 1, the network interface 201 comprises functionality for interfacing with the network through a communication-link with the MSC 101. The network interface 201 is thus operable to receive data from network elements 101-109 of the fixed network as well as to transmit data to the network elements 101-109.

The network interface 201 is coupled to a management processor 203. The management processor 203 comprises functionality for controlling the network elements 101-109 as well as for monitoring the performance of these. The management processor 203 is in particular coupled to a user interface 205 which comprises functionality for displaying properties of the cellular communication system to a network operator. Also the user interface 205 comprises functionality for receiving user inputs which allow the network operator to manually control the network elements 101-109 and thus the characteristics of the cellular communication system.

The management processor 203 is furthermore coupled to a data storage 207. During operation, the management processor 203 can store performance characteristics for individual network elements, for groups of network elements or for the fixed network as a whole. For example, the management processor 203 can statistically process the performance data received from the network elements 101-109 and can store the results in the data storage 207. Thus, the data storage 207 can comprise information of operational parameters and characteristics for the current status of the cellular communication system.

It will be appreciated that the network interface 201, the management processor 203, the user interface 205 and the data storage 207 can perform the functionality of an OMC as will be well known to the person skilled in the art.

The network element manager 111 furthermore comprises a resynchronization processor 209 which is coupled to the management processor 203. The resynchronization processor 209 is arranged to perform a resynchronization operation following a service disruption. In the example of FIG. 2, the resynchronization processor 209 is coupled to an ordering processor 211 and to a service processor 213. In the example, the ordering processor 211 is furthermore coupled to the data storage 207 and the service processor 213 is furthermore coupled to the network interface 201.

During normal service operation, the network interface 201, management processor 203, user interface 205 and data storage 207 can perform conventional OMC functions.

At the same time, the service processor 213 monitors the communication to determine if a service disruption has occurred.

Specifically, the service processor 213 monitors communications with network elements 101-109 supported by the network interface 201 and can therefrom determine if any communication disruptions occur. It will be appreciated that any suitable method or algorithm for determining the communication disruption may be applied without detracting from the invention. For example, the network interface 201 can periodically receive data communications from the first BSC 103. If such data communications are not received from the first BSC or from any of the base stations 107 controlled by the first BSC 103, the service processor 213 can conclude that a communication link has been disrupted to the first BSC 103 and can accordingly determine a service disruption for the first BSC 103.

During a service disruption, the service processor 213 can continue to monitor if any data is received from the first BSC 103 during the service disruption. If the network interface 201 begins to receive further communications at regular intervals from the first BSC 103, the service processor 213 can determine that normal service has been resumed.

Thus, the service processor 213 is arranged to determine service disruptions and service resumption following a disruption. It will be appreciated that many other approaches for determining service disruptions and service resumptions may be used. For example a service disruption can occur as a result of a shutdown and restart of the network element manager 111. The service resumption detection can simply correspond to the restart process of the network element manager 111. Thus, a resynchronization process can be instigated as an inherent part of the initialisation process of the network element manager 111.

When the service processor 213 detects a service disruption, it sends a signal to the resynchronization processor 209. Likewise, when the service processor 213 determines a service resumption, the resynchronization processor 209 is informed of this.

When the resynchronization processor 209 receives an indication of the service disruption from the service processor 213, it sends a control signal to the ordering processor 211. In response, the ordering processor 211 proceeds to determine an order of resynchronization for the network elements 101-109 which are affected by the service disruption. For example, if the service disruption affects all network elements 101-109 managed by the network element manager 111, the ordering processor 211 proceeds to generate an ordered list of all network elements 101-109.

The ordering processor 211 generates the ordered list in response to one or more operational parameters of the network elements. Specifically, the ordering processor 211 can retrieve performance data from the data storage 207 and can evaluate this performance data to generate the ordered list. As a specific example, the ordering processor 211 can retrieve one performance parameter for each affected network element 101-109 from the data storage 207. The network element having the highest parameter value can then be selected as the first network element of the ordered list, the next network element in the list can be selected as the network element having the second highest parameter and so on.

The performance characteristic used for this ordering can be determined during normal operation. For example, the management processor 203 can at periodic intervals determine the performance characteristic for each network element and store this in the data storage 207. When the ordering processor 211 generates the ordered list, this data can be retrieved and as a result an ordered list reflecting the conditions shortly before the service disruption can be generated.

It will be appreciated that many different performance parameters or characteristics may be used to generate the ordered list, either individually or in combination. For example, in many embodiments the following parameters can be used for the ordering:

### Network Element Capacity:

The capacity of the network elements can correspond to the communication traffic that can be supported by the network element. It will be appreciated that in cellular communications system, some network elements are typically configured or dimensioned to support higher capacities than other network elements. For example, a base station located in a densely populated metropolitan area is typically dimensioned to support a higher capacity than a base station located in a sparsely populated rural area, where coverage may be more important than capacity.

The capacity supported by each network element can be stored in the data storage 207, and the ordering processor 211 can order the list in an order of decreasing capacity, such that network elements supporting a higher capacity will be synchronized before network elements supporting a lower capacity. This can allow a faster resynchronization of important network elements thereby reducing the impact of the service disruption to the cellular communication system as a whole.

It will be appreciated that in some embodiments, this measure can also be used to determine a resynchronization order where the higher hierarchical layers of the fixed network tend to be synchronized before the lower hierarchical layers. For example, a BSC can be considered to support a capacity corresponding to the combined capacity of all the base stations supported by the BSC. Accordingly the BSC will be resynchronized before the base stations.

It will furthermore be appreciated, that the capacity characteristic used by the ordering process can be an active capacity which is indicative of the communication capacity that is actively supported before the service disruption.

### A Fault Characteristic:

The ordering processor 211 can alternatively or additionally order the network elements in response to a fault characteristic of the individual network elements. For example, a fault frequency prior to this service disruption can be determined and stored in the data storage 207. Thus, network elements exhibiting a high frequency of faults can be resynchronized prior to network elements exhibiting a lower frequency of faults. This can provide improved fault detection in a cellular communication system and can allow the network operator improved control over unreliable network elements.

In other embodiments, it can be advantageous to resynchronized network elements having low fault frequencies before network elements having high fault frequencies. For example, network elements exhibiting an active fault prior to the service disruption can be likely to also exhibit the fault following the service resumption. Accordingly the network element may not be able to support any mobile stations, and it can therefore be advantageous to resynchronize other network elements which are currently more likely to be able to support mobile stations

### An Alarm Characteristic:

The ordering processor 211 can alternatively or additionally order the network elements in response to an alarm characteristic of the individual network elements. For example, an alarm frequency prior to the service disruption can be determined and stored in the data storage 207. Accordingly, when the service is resumed, network elements exhibiting a high frequency of alarms can be resynchronized prior to network elements exhibiting a lower frequency of alarms. As alarm conditions can require urgent attention in order to prevent or mitigate fault conditions arising, this can allow a network operator to be informed of the status of critical network elements before network elements which are less likely to be in a critical condition.

### A Priority:

Network elements can be assigned a priority, and the ordering processor 211 can generate an ordered list that reflects the assigned priority, this can allow resynchronization of high priority network elements before network elements having a lower priority. Thus, a structured resynchronization of network elements following a service disruption may be achieved wherein more important network elements are resynchronized before less important network elements.

The priority can in some embodiments be manually assigned to the individual network elements by the network operator through the user interface 205. Alternatively or additionally, the priority can be determined in response to measured performance parameters and characteristics. For example the previously mentioned characteristics, such as the capacity, fault frequency and alarm frequency, can be used to determine a relative priority between network elements.

### A Traffic Characteristic:

The ordering processor 211 can generate the ordered list of network elements in response to the traffic which is supported by the different network elements. The traffic supported by a network element can be regularly determined by the management processor 203 and stored in the data storage 207. Thus, when a service disruption occurs, the data storage 207 can comprise information of the supported traffic by each network element in a time interval relatively shortly before the service disruption.

The ordering processor 211 can retrieve this information and order the network elements in an order of decreasing traffic level such that network elements supporting higher traffic levels are resynchronized before network elements supporting lower traffic levels.

It will be appreciated, that any suitable measure of, or algorithm for, determining the traffic level can be used without detracting from the invention. For example, the traffic level for a network element can be measured by the combined data rate supported by the network element and/or by the number of calls supported by the network element.

It will also be appreciated, that in some embodiments the ordering of network elements can be based on historical data measured over a long time period. However, in other embodiments, the ordering processor 211 can be arranged to order the list fully or partially in response to communication characteristics occurring at the service disruption, i.e. which have been determined for a time period which is sufficiently close to the service disruption to be indicative of the conditions when the service disruption occurs. For example, a communication characteristic can periodically be monitored by the management processor 203 and the results stored in the data storage 207. If this is done sufficiently frequently, the last value stored before a service disruption will closely indicate the conditions at the time of the service disruption. Accordingly, the resynchronization can be ordered in accordance with the current conditions and can dynamically be adjusted to suit the conditions at the time of the service disruption.

When the service processor 213 determines that service has been resumed, the resynchronization processor 209 proceeds to retrieve the ordered list from the ordering processor 211. The resynchronization processor 209 then proceeds to control the management processor 203 to sequentially resynchronize the network elements in the order indicated by the ordered list retrieved from the ordering processor 211.

More specifically, in the example of FIG. 2, the resynchronization processor 209 initially selects the network elements listed first in the ordered list, and then proceeds to feed the corresponding network element identity to the management processor 203 together with an instruction to resynchronize with this network element. When the network element has been resynchronized successfully, the management processor 203 informs the resynchronization processor 209. The resynchronization processor 209 then proceeds to provide the management processor 203 with the corresponding network element identity and an instruction to resynchronize with this network element. This process is repeated until all network elements in the ordered list have been successfully resynchronized.

The invention can allow an improved resynchronization process following a service disruption associated with a network element manager. For example, the most important revenue generating network elements can be resynchronized first after a network element manager or link outage. This can be particularly important in large networks. For example UMTS element managers are designed that can manage up to thousands base stations and ten or more Radio Network Control elements.

Resynchronization of the fault and state information of the network may in such cases typically take up to one hour. Resynchronization of the statistics from the network may take even longer (particular if the element manager has been out of contact for an extended period—e.g. due to a major upgrade of the element manager). Therefore, in such a network, it is particularly important to present an accurate view of the most important revenue generating network elements as soon as possible.

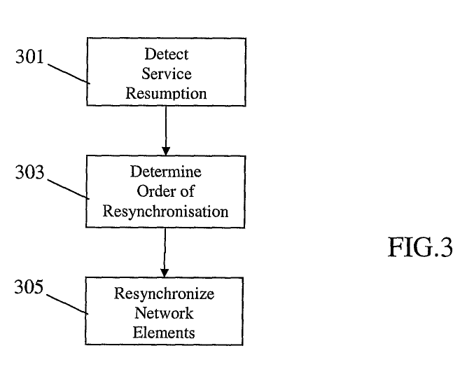

FIG. 3 illustrates a method of resynchronization for a plurality of network elements of a communication system in accordance with embodiments of the invention.

The method initiates in step 301 wherein a service resumption following a service disruption associated with the plurality of network elements is determined.

Step 301 is followed by step 303 wherein an order of resynchronization for the plurality of network elements is determined in response to at least one operational characteristic of the plurality of networks.

Step 303 is followed by step 305 wherein the plurality of network elements is resynchronized in the determined order.

The method is applicable to the network element manager 111 of FIGS. 1 and 2.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers can be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention can optionally be implemented at least partly as computer software running on one or more data processors and/or digital signal processors. The elements and components of an embodiment of the invention can be physically, functionally and logically implemented in any suitable way. Indeed the functionality can be implemented in a single unit, in a plurality of units or as part of other functional units. As such, the invention can be implemented in a single unit or can be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments can be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these can possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps can be performed in any suitable order. In addition, singular references do not exclude a plurality. Thus references to “a”, “an”, “first”, “second” etc do not preclude a plurality.

1. A network element manager for managing a plurality of network elements of a communication system, the network element manager comprising:
means for detecting a service resumption following a service disruption associated with the plurality of network elements;
ordering means for determining an order of resynchronization for the plurality of network elements in response to at least one operational characteristic of the plurality of network elements; and
resynchronizing means for resynchronizing the plurality of network elements following the service resumption in the determined order of resynchronization.

2. The network element manager of claim 1 wherein the ordering means is arranged to determine an operational characteristic for each of the plurality of network elements, and to order the plurality of network elements in order of the operational characteristic.

3. The network element manager of claim 1 wherein the at least one operational characteristic for each of the plurality of network elements comprises one of the group of; a capacity characteristic, a priority characteristic, a traffic characteristic, a fault characteristic for each of the plurality of network elements, and an alarm characteristic.

4. The network element manager of claim 3 wherein the fault and alarm characteristics comprises a frequency prior to the service resumption.

5. The network element manager of claim 1 further comprising means for dynamically determining the at least one operational characteristic for each of the plurality of network elements during non-service disrupted operation.

6. The network element manager of claim 1 wherein the at least one operational characteristic comprises a communication characteristic at the service disruption.

7. The network element manager of claim 1 wherein the service disruption comprises a communication disruption between the network element manager and at least one of the plurality of network elements.

8. The network element manager of claim 1 wherein the resynchronizing means is arranged to sequentially synchronize information between the network element manager and each of the plurality of network elements in the resynchronization order.

9. The network element manager of claim 8 wherein the information comprises one of the group of; network element configuration data, network element state data, and network element alarm data.

10. A method of resynchronization for a plurality of network elements of a communication system, the method comprising:
determining a service resumption following a service disruption associated with the plurality of network elements;
determining an order of resynchronization for the plurality of network elements in response to at least one operational characteristic of the plurality of networks; and
resynchronizing the plurality of network elements following the service resumption in the determined order of resynchronization.
